(19) United States
(12) Patent Application Publication
(10) Pub. No.: US 2024/0409102 A1
(43) Pub. Date: Dec. 12, 2024

(54) PRE-EMPTIVE SUSPENSION LOADS MANAGEMENT SYSTEM

(71) Applicant: JAGUAR LAND ROVER LIMITED, Warwickshire (GB)

(72) Inventors: Adrian Bouaru, Whitley, Coventry, Warwickshire (GB); Alexander Wojtecki, Whitley, Coventry, Warwickshire (GB)

(21) Appl. No.: 18/702,464

(22) PCT Filed: Oct. 18, 2021
(86) PCT No.: PCT/EP2021/078804

§ 371 Date: Apr. 18, 2024

(51) Int. Cl. B60W 40/06; B60W 10/22; B60W 40/105; B60W 50/00

(52) U.S. Cl. CPC B60W 40/06; B60W 10/22; B60W 40/105; B60W 50/0097; B60W 2520/10; B60W 2555/00; B60W 2710/22

(57) ABSTRACT

Aspects relate to systems and methods for pre-emptively managing suspension loads. A control system (100, 200) is configured to receive a driving surface signal (165) indicative of a property of a driving surface ahead of the vehicle (600). The control system is further configured to determine, in dependence on the received driving surface signal and on a current vehicle operational state, an attribute parameter. The attribute parameter, when provided to an actuator (318a, 318b . . . 318z) of the suspension system, causes the actuator to act to control a suspension force acting on the suspension system due to a movement of the vehicle along the driving surface to be below a predetermined suspension force value. The control system is further configured to output an actuator control signal (155) to the actuator of the suspension system to control the actuator in dependence on the determined attribute parameter.

### TECHNICAL FIELD

The present disclosure relates to a pre-emptive suspension loads management system. Aspects relate to a control system, to a system, to a vehicle and to a method for pre-emptively managing suspension loads.

### BACKGROUND

Vehicles typically comprise active suspension systems, such as an electronic active roll control system, for maintaining vehicle stability. A suspension system for a vehicle may reduce the forces experienced by the vehicle and the users of the vehicle as a result of a condition of a road or other driving surface. This both improves the comfort of the users and reduces the likelihood of vehicle components prematurely failing by the suspension system accommodating changes such as roughness or local peaks and troughs in the driving surface as the vehicle travels over the surface.

In normal operation, the configuration of the suspension system is biased towards obtaining a desired attribute behaviour, such as minimising a response time to achieve the best dynamic response. This control configuration can lead to loads within the suspension system or vehicle system which exceed desired values. High load values may lead to performance degradation over time and premature component failures. This may then, in turn, lead to end user dissatisfaction.

Traditionally, reactive algorithms are used to achieve a desired configuration of the suspension system. This may result in compromising the attributes of the system in an attempt to achieve load targets but may not guarantee that the loads will remain at the desired limits under all vehicle use cases. Alternatively, the reactive algorithm may ignore the loads experienced by the vehicle and accept that there will be premature component damage.

It is an aim of the present disclosure to address one or more of the disadvantages associated with the prior art.

### SUMMARY OF THE INVENTION

Aspects and embodiments of the invention provide a control system, a system, a vehicle and a method as claimed in the appended claims

According to an aspect there is provided a control system for a suspension system of a vehicle. The control system comprises one or more controllers, and the control system configured to receive a driving surface signal indicative of a property of a driving surface ahead of the vehicle. The control system is further configured to determine, in dependence on the received driving surface signal and on a current vehicle operational state, an attribute parameter. The attribute parameter, when provided to an actuator of the suspension system, causes the actuator to act to control a suspension force acting on the suspension system due to a movement of the vehicle along the driving surface to be below a predetermined suspension force value. The control system is further configured to output an actuator control signal to the actuator of the suspension system to control the actuator in dependence on the determined attribute parameter.

A driving surface signal may comprise a signal received from one or more sensors, cameras, databases or external devices which provides information indicating a condition, feature or characteristic of a driving surface. The driving surface signal may provide information relating to raw data obtained or received from the one or more sensors, cameras, databases or external devices. The raw data may be unprocessed data, and may not have an identifiable specific physical meaning prior to receipt. The driving surface signal may provide information relating to processed data obtained or received from the one or more sensors, cameras, databases or external devices. The driving surface may be a road, off-road track, or any other surface on which a vehicle may be driven.

The condition of the driving surface may relate to factors such as a terrain, slope or roughness of the driving surface, the presence or absence of features such as pot holes or speed bumps, or any other factor which may affect the road handling of the vehicle.

A driving surface ahead of the vehicle refers to an area which is likely to be occupied by the vehicle in the near future. The driving surface ahead of the vehicle is the surface in the direction of travel of the vehicle. For a vehicle travelling in a forwards direction, the driving surface ahead of the vehicle may be the surface in front of the vehicle, in a direction that the vehicle is facing. For a vehicle that is reversing, the driving surface ahead of the vehicle may be the surface behind or to the rear of the vehicle, in a direction opposite to the direction in which the vehicle is facing. For a stationary vehicle, the driving surface ahead of the vehicle may be the driving surface in front of the vehicle, in the direction that the vehicle is facing. Alternatively, for a stationary vehicle, the driving surface ahead of the vehicle may be the driving surface either in front of or behind the vehicle in dependence on an indicator of a likely intent of a user, such as a position of a gear selector of the vehicle.

A current operational state of the vehicle may relate to a parameter of a current state of the vehicle, such as a speed of the vehicle or a mass of the vehicle. The current operational state of the vehicle may relate to current internal control settings of the vehicle, such as a current setting of one or more suspension components of the vehicle.

A suspension force acting on the vehicle may be a force, load or torque acting on one or more components of the vehicle as a result of the vehicle travelling on a driving surface. In particular, the suspension force may be a force acting on one or more components of a suspension system of the vehicle. A suspension force may act on the suspension system, or on one or more components of the suspension system, due to the movement of the vehicle along the driving surface in combination with any active forces generated by the components within the suspension system.

An attribute parameter may be a setting for a component of the vehicle. In particular, an attribute parameter may be a setting for a component of a suspension system of the vehicle. More particularly, the attribute parameter may be a setting for an actuator of the suspension system of the vehicle. The attribute parameter may cause an actuator to change a current operational setting of the actuator. The attribute parameter may thereby influence the control that an actuator has on the suspension force acting on the vehicle.

An actuator control signal may be a signal output from a control system and received by a suspension system of a vehicle. In particular, the actuator control signal may be transmitted from a controller and received by an actuator. An actuator receiving an actuator control signal may change one or more settings, configurations or operational modes of the actuator based on the data included in the actuator control signal. The data included in the actuator control signal may relate to the determined attribute parameter.

Advantageously, the control system may pre-emptively adjust the settings of one or more actuators of the vehicle prior to the vehicle reaching a portion of a driving surface on which the vehicle may be subjected to an undesirably large force acting on the vehicle.

Further advantageously, the settings of the actuators may be adjusted to achieve the best compromise between multiple desired attributes of the vehicle, whilst ensuring that the forces or loads acting on the vehicle remain within an acceptable range.

Further advantageously, this pre-emptive system reduces the suspension force acting on the vehicle more quickly than a reactive system. This reduces the performance degradation of one or more components of a vehicle over time, and reduces the likelihood of components prematurely failing. Moreover, the vehicle may offer an improved level of driver involvement and the occupants of the vehicle may have a more comfortable journey. The overall satisfaction of a user or owner of the vehicle is therefore increased.

Optionally, the control system is configured to determine the attribute parameter in dependence on a vehicle model, and on the current vehicle operational state, to determine a predicted suspension force expected to arise as the vehicle travels over the driving surface ahead of the vehicle. That is, a predicted suspension force experienced by the vehicle may be determined based on a current vehicle operational state and a vehicle model, wherein the predicted suspension force may in turn be used to determine the attribute parameter. The vehicle model may predict the loads or forces which are likely to occur as the vehicle passes over the driving surface ahead of the vehicle.

Advantageously, the use of the vehicle model and the determination of a predicted suspension force that is expected to be experienced based on the current operational settings of the vehicle helps to more accurately determine the attribute parameter required to keep the suspension force below the predetermined suspension force value. This helps improve the longevity of the vehicle components by better maintaining an experienced suspension force below the predetermined suspension force limit value. This also helps to improve the compromise between a plurality of desired vehicle attributes whilst ensuring that the loads experienced by the vehicle remain below an acceptable level.

Additionally, instances of fatigue failure may be mitigated by reducing or minimising the number of occurrences of high suspension force values, even if these high suspension force values are below the predetermined suspension force limit value. That is, an attribute parameter may still be determined and implemented to control a suspension force acting on one or more components of the suspension force, even if a predicted suspension force is already below the predetermined suspension force value.

Optionally, the predicted suspension force is determined using the vehicle model by predicting a motion of the vehicle over the driving surface ahead of the vehicle, and predicting a force that will arise from the predicted motion of the vehicle.

Optionally, if the predicted suspension force is greater than the predetermined suspension force value, the attribute parameter is determined in order to bias the control towards limiting loads; and if the predicted suspension force is less than the predetermined suspension force value, the attribute parameter is not determined.

Advantageously, this ensures that the settings of the actuator are only biased away from the default attribute compromise if it is necessary to keep the suspension force experienced by the vehicle below a predetermined threshold suspension force. Since the settings of the actuator are not changed to prioritise loads management, a default desired compromise between the plurality of vehicle attributes is maintained. Moreover, only changing the settings of the actuator when necessary simplifies the interactions with other subsystems within the vehicle suspension.

Alternatively, if the predicted suspension force is less that the predetermined suspension force value, the attribute parameter may still be determined in dependence on an alternative parameter, such as a desired attribute compromise. The desired attribute compromise may be a default desired attribute compromise.

Optionally, the control system is further configured to determine the attribute parameter in dependence on one or more of a driver model, a loads estimation model, and the current vehicle operational state, to determine a predicted path of the vehicle.

A driver model may be used to predict a path of the vehicle. The driver model may use data retrieved from vehicle sensors, an internal database and/or an external database to predict the path of the vehicle.

The driver model, in combination with knowledge of the suspension control systems, may generate a prediction of driver-induced active forces generated by the suspension system actuators and other components within the vehicle. The driver model may predict a vehicle body motion resulting from a driver input such as a steering input. Determining the predicted loads or forces acting on one or more components of the suspension system may be performed in dependence on the predicted driver-induced forces.

Advantageously, predicting the driver induced active forces generated by the suspension system actuators enables improved determination of the attribute parameter value. This allows the actuators to better control the suspension forces acting on the suspension system as the vehicle travels along the driving surface.

Further advantageously, predicting the vehicle body motion resulting from a driver input also enables improved determination of the attribute parameter value. This also allows the actuators to better control the suspension forces acting on the suspension system as the vehicle travels along the driving surface.

Advantageously, predicting a route that a vehicle is likely to take enables the control system to more accurately determine the attribute parameter required to keep a suspension force below a predetermined suspension force value.

Optionally, the driver model represents a predicted vehicle operation by a user of the vehicle, the predicted vehicle operation determined in dependence on at least one of the property of the driving surface and a route history pattern of the vehicle.

The driver model may be extended by including historical data regarding vehicle operation by a user of the vehicle. This enables the control system to predict the vehicle operation by a user of the vehicle; the predicted vehicle operation determined in dependence on at least one of the properties of the driving surface and a route history pattern of the vehicle.

For example, the driver model may use data obtained by the sensors to distinguish between a dedicated road surface intended for vehicles and a non-road surface which is not intended for vehicles (such as a pedestrian path). The driver model may use this data to predict that the path of the vehicle will be along the dedicated road surface rather than the non-road surface, even if the non-road surface would provide a smoother journey.

For example, the driver model may use historical data regarding vehicle operation by a user of the vehicle to determine that the user typically adjusts the vehicle speed when passing over a speed bump. This would enable the controller to adjust the degree of attribute compromise due to loads management to a much less severe level than required for passing over the same obstacle at a higher speed.

Moreover, the driver model may predict that a driver of the vehicle will take some preventative measures to avoid driving surface features which could cause damage to the vehicle. For example, a driver may be expected to steer around a large pothole or an obstruction in the driving surface, and so the driver model will predict an appropriate vehicle path accordingly.

As another example, a driver may be expected to avoid large dips and troughs in a driving surface, particularly in an off-road driving situation, and to generally try to drive along the most level route available. The driver model will then predict a vehicle path according to the expected driver behaviour and the property of the driving surface.

Furthermore, the driver model may predict a path of a vehicle based on previous user habits stored in an internal or external database. Such information may form a route history pattern of the vehicle. For example, a vehicle may regularly make a particular journey at particular times, such as if a user of the vehicle is commuting to or from a place of work. The driver model may predict a path in dependence on the stored information to predict, for example, a direction that the vehicle may take at a particular junction.

Advantageously, these features enable the driver model to more accurately predict a motion of the body of the vehicle. This in turn enables the control system to better determine the attribute parameter required to keep a suspension force below a predetermined suspension force value.

Optionally, the current vehicle operational state comprises one or more of: a current speed, a current acceleration; a vehicle body motion, a wheel vertical displacement value, a wheel vertical speed, a wheel vertical acceleration, and a current suspension control state of the vehicle. The current speed comprises a vehicle longitudinal and/or lateral speed. The current acceleration may comprise a vehicle longitudinal and/or lateral acceleration. The vehicle body motion may comprise one or more of a body roll, a pitch, and a yaw, and any of their corresponding time derivatives.

Optionally, the current vehicle operational state comprises the current speed of the vehicle, and the control system is configured to coordinate in time the output of the actuator control signal to the actuator to control the actuator to be in a desired state with the upcoming driving surface. For example, the control system may be configured to apply a time delay to output the actuator control signal to the actuator to control the actuator to be in a desired state when the vehicle reaches a portion of the driving surface whereby the suspension force is to be controlled to be below the predetermined threshold suspension force. The current vehicle operational state may also comprise the current acceleration of the vehicle Advantageously, this coordination allows the suspension system of the vehicle to be in the desired state when the vehicle reaches the particular area of the driving surface for which the actuator adjustments are required.

Further advantageously, coordinating the output of the actuator control signal prevents the actuator from being prematurely adjusted. Prematurely adjusting the actuator is undesirable because it may lead to the suspension system being in a less appropriate state for current driving surface conditions, which could lead to larger than desired suspension forces being applied to the vehicle. Moreover, prematurely adjusting the actuator may lead to attributes of the vehicle being undesirably compromised for longer than is necessary, which can lead to a decrease in vehicle performance and therefore a decrease in customer satisfaction.

The current vehicle operational state may comprise both the current speed of the vehicle and a current acceleration of the vehicle. Advantageously, this allows the time delay to be more accurately determined.

Optionally, the control system is further configured to control the actuator to revert to a state that the actuator was in prior to receiving the actuator control signal, once the vehicle has passed a portion of the driving surface whereby the suspension force is to be controlled to be below the predetermined threshold suspension force.

Alternatively, the actuator may revert to a state that the actuator was in prior to receiving the actuator control signal once the predicted loads or forces acting on one or more components of the suspension system are below a second suspension force threshold. The second suspension force threshold may be the same as, or different to, the suspension force value above which the actuator acts to control the suspension force in dependence on the attribute parameter.

Advantageously, this precludes scenarios of repeated toggling of the attribute parameter, thereby improving consistency of the control. Overall, the amount of time the vehicle is in a less-than-optimal overall configuration is minimised, so the overall operational performance of the vehicle is improved.

Optionally, the control system further comprises one or more sensors configured to obtain driving surface data relating to one or more properties of the driving surface ahead of the vehicle.

The sensors may comprise LIDAR sensors, cameras, or any other sensors or devices which are configured to extract data relating to features of a driving surface ahead of the vehicle. The sensors may further comprise computer vision sensors and models which use external sources to extract feature information relating to a driving surface ahead of the vehicle.

The sensors may obtain height data relating to features on the driving surface ahead of the vehicle to give, for example, a depth of a pothole or a height of a speedbump. The sensors may also obtain data relating to how far away a detected feature of the driving surface is from the vehicle. In addition, the sensors may obtain data relating to a speed at which the vehicle is travelling.

The sensors may be sensors which are already incorporated into the vehicle for other purposes. That is, it may not be necessary to include any additional sensors into the vehicle in order to obtain the desired information relating to a property of the driving surface ahead of the vehicle. The control system may therefore use data which is already available to determine the attribute parameter and pre-emptively control the suspension system of the vehicle.

The sensors may obtain data that needs to be processed in order to obtain data which is usable by the control system. For example, an accelerometer may provide a voltage level proportional to an acceleration. One or more processors may then process the voltage level data to obtain an acceleration value. The sensors may obtain data which is usable by the control system without any further processing. For example, an accelerometer may provide an acceleration value.

Optionally, the suspension system comprises one or more of an active roll control system, an active damping system, an active spring system, an active steering system, and an active suspension system.

The vehicle suspension system may comprise one or more of active damping components, active roll control components and active steering components at one or more of the front and rear axles.

According to a further aspect, there is provided a system comprising any control system disclosed herein and a suspension system as disclosed herein.

According to a further aspect, there is provided a vehicle comprising any control system disclosed herein.

According to a further aspect, there is provided a method of operating a control system for a suspension system of a vehicle. The method comprises receiving a driving surface signal indicative of a property of a driving surface in ahead of the vehicle. The method further comprises determining, in dependence on the received driving surface signal and on a current vehicle operational state, an attribute parameter. The attribute parameter, when provided to an actuator of the suspension system, causes the actuator to act to control a suspension force acting on the suspension system due to a movement of the vehicle along the driving surface to be below a predetermined suspension force value and outputting an actuator control signal to the actuator of the suspension system to control the actuator in dependence on the determined attribute parameter.

In a further aspect there is provided computer software that, when executed, is configured to perform any method disclosed herein. Optionally the computer software is stored on a computer readable medium. Optionally the computer software is tangibly stored on a computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more examples will now be described, by way of example only, with reference to the accompanying drawings, in which:

FIG. 1 shows a controller of an apparatus according to examples disclosed herein;

FIG. 2a shows a control system for a vehicle connected to front and rear anti-roll bars according to examples disclosed herein;

FIG. 2b shows a control system for a vehicle comprising plural sub-systems, and front and rear anti-roll bars according to examples disclosed herein;

FIG. 3 shows an example controller process according to examples disclosed herein;

FIG. 4 shows an example method according to examples disclosed herein;

FIG. 5 shows a further example method according to examples disclosed herein; and

FIG. 6 shows a vehicle according to examples disclosed herein.

### DETAILED DESCRIPTION

Active suspension systems, such as electronic active roll control utilizing mechatronic systems, may include a cascade of systems, such as:
(a) a high level vehicle control layer, which may generate system demand signals (for example torque demands) to influence vehicle motion;
(b) a low level control layer, which may provide control signals to actuators (for example motor control) to deliver the demanded signal from the high level control; and
(c) a physical actuation layer, comprising motors and associated mechanical components to deliver the physical manifestation of the demanded signal.

Load reaction through the suspension and anti-roll control systems depends on the interaction between active control and mechanical reaction of neighbouring suspension elements/systems. In normal operation the configuration of the active control may be biased towards a desired attribute behaviour (for example, reducing response time to achieve high dynamic response, or reducing torque zero crossings to mitigate actuator knock). Such control configuration may lead to loads within the active roll control system or within the vehicle system, that may exceed desired values. High load values may in turn lead to performance degradation over time and premature component failures. Traditionally, reactive algorithms may be used to achieve the desired targets, which results in attribute compromise.

Examples disclosed herein use pre-emptive scanning of the road surface in front of the vehicle to identify conditions which could lead to high loads. Combining this information with knowledge about the vehicle state (for example speed, internal control states, operational values of other suspension actuators), allows for the vehicle control system to adjust its active control setpoint to achieve an improved compromise between the desired vehicle attributes, while aiming to ensure loads remain within an acceptable range. The loads adjusted control requests may be coordinated to help ensure the suspension system is in a desired state when the vehicle reaches the particular road input region. After the vehicle passes the particular road input, normal control may resume to reduce the period of time for which more restrictive attribute compromise may be employed to handle the particular road surface. If a load event is predicted, then attributes of the suspension and vehicle system may be compromised with respect to their individual normal operation, in order to control loads. If no loads event is predicted, then this means expected loads on the suspension system are within allowable bounds, and so normal operation may be possible for all other attributes.

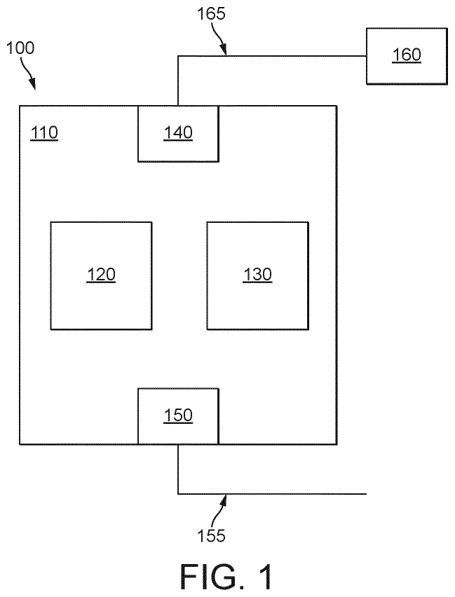

With reference to FIG. 1, there is illustrated a control system 100 for a suspension system of a vehicle. The control system 100 comprises one or more controllers 110. The control system 100 as illustrated in FIG. 1 comprises one controller 110, although it will be appreciated that this is merely illustrative. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input 140 of the controller 110. The output means 150 may comprise an electrical output 155 of the controller 110. The input 140 is arranged to receive a driving surface signal 165 from a sensing means 160. The sensing means 160 may comprise one or more sensors on the vehicle.

The driving surface signal 165 is an electrical signal which carries data indicative of a property of a driving surface ahead of the vehicle. The data may be raw, unprocessed, data which only obtains meaning in relation to the driving surface characteristics after the data has been processed by the processing means 120. The processing means is configured to determine, in dependence on the received driving surface signal and on the current vehicle operational state, an attribute parameter. The attribute parameter, when provided to an actuator of the vehicle, causes the actuator to control a suspension force acting on the suspension system due to a movement of the vehicle along the driving surface. The attribute parameter is determined to keep the suspension force acting on the suspension system below a predetermined suspension force value.

The input means 140 may be further configured to receive data indicative of a current vehicle operational state. The data indicative of a current vehicle operational state may comprise data relating to the operational settings of the actuators of the suspension system, a current weight distribution of the vehicle, the operational settings of other internal control systems of the vehicle, or any other data which may affect the operation of the vehicle. The data received by the input means 140 may be raw, unprocessed, data which only obtains meaning in relation to the current vehicle operational state after the data has been processed by the processing means 120.

The output 150 is arranged to output an actuator control signal 155 to an actuator of the vehicle for controlling a suspension force acting on the suspension system due to a movement of the vehicle along the driving surface. The actuator control signal is transmitted in dependence on the determined attribute parameter. The actuator control signal transmits data relating to the determined attribute parameter to an actuator of the suspension system.

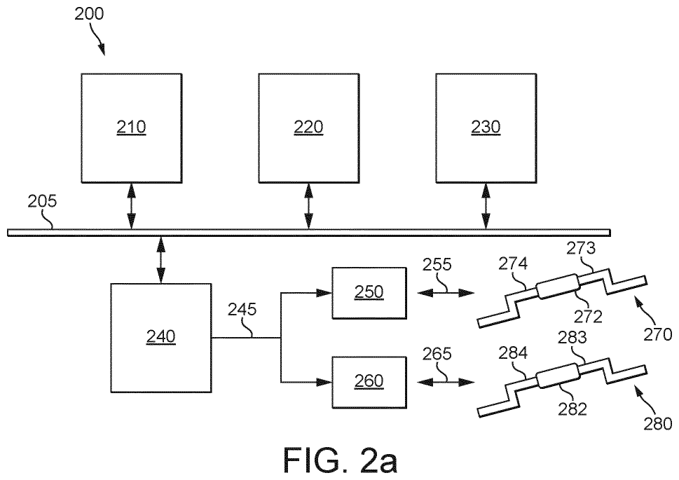

FIGS. 2a and 2b illustrate example control systems 200 for a suspension system of a vehicle. A suspension system of a vehicle may comprise anti-roll bars 270, 280 which are controlled using an anti-roll control system. The anti-roll control system acts to control the anti-roll bars, to control a roll of a body of the vehicle and reduce the impact of disturbances from a road surface. The anti-roll control system may be electromechanical and/or hydraulic. Anti-roll bars 270, 280 may typically comprise may typically comprise stabiliser bars, typically metal, which join the vehicle suspension on either side of the vehicle axle, usually through drop links, and connect to a rotational actuator situated between the mounting points to the vehicle chassis. Each side of the anti-roll bar is able to rotate freely when a motor of the anti-roll control system is not energised. When the motor control is enabled (i.e., delivering torque), the anti-roll bar may act as a torsional spring. The anti-roll bars may be controlled to compensate for some vehicle movements such as body roll, for example from driving around a corner. Body roll can cause the wheels at the side of the vehicle outside the turn to reduce their contact with the road surface. Anti-roll bars may be controlled to counteract this effect and reduce the body roll effect, by transferring at least part of the additional load on the wheels at the side of the vehicle inside the turn to those wheels at the outside, for example by providing a torsional effect to pull the wheels towards the chassis and even out the imbalance in load on the wheels caused by cornering.

A typical suspension system may comprise passive front and rear anti-roll bars provided respectively between the front and rear pairs of wheels of a standard four-wheel vehicle. In a vehicle with an active roll control system, an anti-roll bar 270, 280 may respectively comprise two anti-roll bar ends 273, 274; 283, 284 connected together by a central housing having an actuator 272, 282. The central housing may additionally have one or more of a gearbox, sensors, and dedicated actuator controllers. The actuator 272, 282 acts to provide an actively controlled torque rather than a fixed torsional stiffness provided by passive anti-roll bars. One or more sensors may monitor the movement of the vehicle, and provide the sensed parameters as input to the active roll control system to control the actuator 272, 282 and provide a suitable torque to the anti-roll bar. The two ends of the anti-roll bar 273, 274; 283, 284 may be identical, or may be non-identical.

FIG. 2a shows an example control system 200 for a suspension system a vehicle, communicatively connected to front and rear anti-roll bars 270, 280. The control system 200 comprises a controller 240 which is connected by a communication channel 245 to anti-roll bar controllers 250, 260 configured to respectively control front and rear anti-roll actuators 272, 282. The controller 240 may be the controller 110 of FIG. 1. The controller 240 may comprise one or more of the controllers 110 of FIG. 1. In an example, the controller 240 may be a master controller for an electronic active roll control system in the vehicle. The controller 240 may host a vehicle level control strategy and actuation control for the electronic active roll control system in the vehicle.

The controller 240 may be configured to receive one or more sensor signal 203 from one or more sensors attached to the vehicle. The one or more sensors signals 203 may comprise, for example, a signal from a respective suspension height sensor of the vehicle suspension; a signal from a respective hub acceleration sensor of the vehicle; and a signal from a respective torque sensor for the anti-roll bar actuators 272, 282. A signal from a respective motor position sensor for the anti-roll bar actuators 272, 282 may be communicated to the controller 240 via the communication link 245. A suspension height sensor may be configured to determine a sensor signal indicative of one or more of a height of a left side and a height of a right side of the vehicle suspension. A motor position sensor may be configured to determine a sensor signal indicative of a position of a respective motor of the anti-roll bar actuators 272, 282. A hub acceleration sensor may be configured to determine a sensor signal indicative of an acceleration of one or more hub of a wheel of the vehicle. A torque sensor may provide a measure of an existing torque generated in the system, as a result of a target torque demand being requested by the controller 240.

The controller 240 may be configured to receive one or more communication signals via a communications bus 205. The communications bus 205 may be configured to deliver data to the controller 240 from other subsystems within the vehicle. For example, the communications bus 205 may be configured to communicate a signal indicating a status of one or more modules 210, 220, 230 that are in communicative connection with the controller 240 to the controller 240. In another example, the communications bus 205 may be configured to communicate a command from the controller 240 to the one or more modules 210, 220, 230 that are in communicative connection with the controller 240. The one or more modules 210, 220, 230, are discussed further in relation to FIG. 2b below. Signals transmitted over connections 203 or 245 may alternatively or additionally be transmitted over communications bus 205.

The controller 240 may be configured to generate system demand signals to influence a vehicle's motion via the anti-roll actuators 272, 282. An actuator provided between a front pair of wheels of a vehicle may be called a front actuator. A front active roll control (FARC) module may be electrically connected to the front actuator, and may comprise the controller 250 to control the front actuator 272. Similarly, an actuator provided between a rear pair of wheels of a vehicle may be called a rear actuator. A rear active roll control (RARC) module may be electrically connected to the rear actuator and may comprise a controller 260 to control the rear actuator 282.

The front and rear anti-roll actuators 272, 282 each comprise an electric motor which is controllable by the respective anti-roll controller 250, 260. Each of the front and rear anti-roll actuators 272, 282 may be controlled by its own respective anti-roll controller in some examples, or multiple anti-roll actuators may be controlled by a common anti-roll controller in some examples. Each of the anti-roll actuators 272, 282 may be individually controlled in some cases to improve the management of the roll of the body of the vehicle. The front and rear anti-roll actuators 272, 282 may be controlled by a control signal which is generated by the controller 240 may generate and output, through the output channel 255, 265, to the anti-roll bar controllers 250, 260, which then use the communication channel 245 to exchange data with the controller 240. The control signal may carry instructions to be implemented by the actuator, for example by providing a torque to apply to the anti-roll bar. For example, as discussed above, when the vehicle is cornering, a control signal may be transmitted to the anti-roll bar controllers 250, 260, which may in turn transmit a control signal via the interface 255, 265, so that the front and rear anti-roll actuators 272, 282 may mitigate a body roll effect. Similarly, anti-roll bar controllers 250, 260 may transmit measured values from the anti-roll actuators 272, 282 to the controller 240 through output channel 245.

FIG. 2b shows an example control system 200 for a vehicle comprising one or more modules 210, 220, 230, a controller 240 and front and rear anti-roll bars 270, 280. As in FIG. 2a, the control system 200 comprises a controller 240 which is connected by a communication channel 245 to controllers 250, 260 configured to respectively control front and rear anti-roll bar actuators 272, 282. Further, the controller 240 of the control system 200 is in a communicative connection to the one or more modules 210, 220, 230 via a communications bus 205. The one or more modules 210, 220, 230 may be configured to perform functions relating to power supply of the suspension system. Module 210 may be a power control module configured to control a power supply system for the suspension system. Module 220 may be a conversion module configured to convert electrical energy output from a vehicle power supply system. In an example, the conversion module 220 may comprise a DC-DC converter. Module 230 may be a capacitor or supercapacitor module configured to store electrical energy for the suspension system. Together, conversion module 220 and capacitor module 230 may be configured to supply electrical energy to the controllers 250, 260, such that the anti-roll bar actuators 272, 282 can be actuated. FIG. 2b illustrates these modules 210, 220, 230 as individual modules. However, there may be examples whereby components within the modules 210, 220, and 230 are included in a single module. Similarly, communications links 205 and 245 may be the same in some examples.

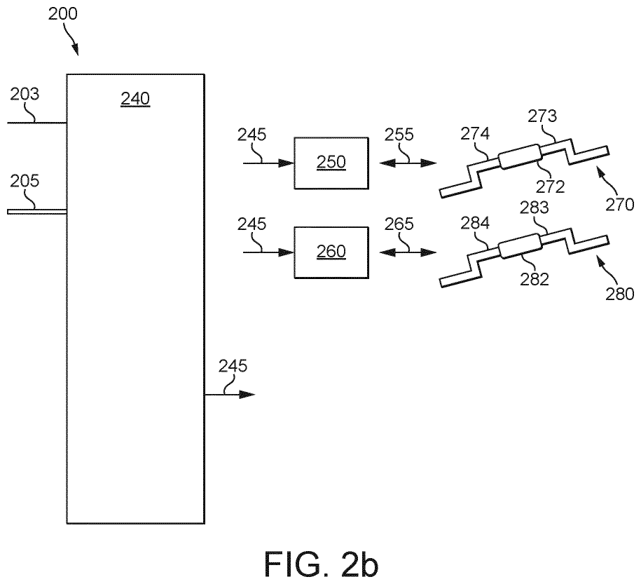

FIG. 3 shows an example controller process 300. Data received from one or more sensors 302 is provided to a vehicle input fusion unit 304. The vehicle input fusion unit 304 may receive and store both raw and pre-processed data. The vehicle input fusion unit 304 may further process any of the received data, and store this processed data. The vehicle input fusion unit 304 may transmit the data stored within to one or more of a loads estimation unit 306, a driver model unit 308 and a vehicle model unit 310.

The loads estimation unit 306 may estimate a load that is likely to act on a component of the vehicle as the vehicle travels along the driving surface. The loads estimation unit 306 may determine the estimation in dependence on the data received from the vehicle input fusion unit 304.

The driver model unit 308 may estimate a path of the vehicle. The driver model unit 308 may determine an estimation of the path of the vehicle in dependence on the data received from the vehicle input fusion unit 304. The driver model unit 308 may transmit data relating to the estimated path of the vehicle to the loads estimation unit 306 to enable the loads estimation unit 306 to determine an estimated load that is likely to act on a component of the vehicle in dependence on the estimated path. By sharing data in this way, the loads estimation unit may more accurately determine an estimated load acting on one or more components of the vehicle as the vehicle travels along the driving surface.

The vehicle model unit 310 may predict the expected movement of one or more components of the vehicle arising as a result of the vehicle travelling along a driving surface ahead of the vehicle. The vehicle model unit 310 may predict the movement of one or more components of the vehicle in dependence on the data received from the vehicle input fusion unit 304.

The vehicle model unit 310 may transmit data relating to the estimated movement of one or more components of the vehicle to the loads estimation unit 306 to enable the loads estimation unit 306 to determine an estimated load that is likely to act on a component of the vehicle in dependence on the predicted movement of one or more components of the vehicle. By sharing data in this way, the loads estimation unit may more accurately determine an estimated load acting on one or more components of the vehicle as the vehicle travels along the driving surface.

The vehicle model unit 310 may comprise a sprung mass vehicle model unit 312 and an unsprung mass vehicle model unit 314. An unsprung mass comprises one or more of the wheels, tires and suspension components of the vehicle. That is, an unsprung mass comprises elements of the suspension system outboard of the springs. A sprung mass comprises elements such as the body of the vehicle, the engine, and users within the vehicle. That is, a sprung mass comprises elements which are not an unsprung mass. The sprung mass vehicle model unit 312 predicts the movement of the sprung masses of the vehicle. The unsprung mass vehicle model unit 314 predicts the movement of the unsprung masses of the vehicle. The vehicle model unit 310 may combine and process the predicted movements determined by the sprung mass vehicle model unit 312 and the unsprung mass vehicle model unit 314 to determine an overall prediction of the relative motion of the suspension relative to the vehicle body.

The driver model unit 308 and the vehicle model unit 310 may operate separately or cooperatively. When operating cooperatively, the driver model unit 308 may transmit data relating to the estimated path of the vehicle to the vehicle model unit 310 to enable the vehicle model unit 310 to predict the movement of one or more components of the vehicle in dependence on the estimated path of the vehicle. By sharing data in this way, the vehicle model unit 310 may more accurately predict the movement of one or more components of the vehicle.

When operating cooperatively, the vehicle model unit 310 may transmit data relating to the estimated movement of one or more components of the vehicle to the driver model unit 308 to enable the driver model unit 308 to estimate a path of the vehicle in dependence on the predicted movement of one or more components of the vehicle. By sharing data in this way, the driver model unit 308 may more accurately determine an estimated path of the vehicle. When the driver model unit 308 and the vehicle model unit 310 are operating cooperatively, it is not necessary for both units to transmit data to the other unit. It is sufficient for only the driver model unit 308 to transmit data to the vehicle model unit 310, or vice versa. Alternatively, the driver model unit 308 and the vehicle model unit 310 may both transmit data to the other unit.

The loads estimation unit 306, the driver model unit 308 and the vehicle model unit 310 may each transmit a signal to the control model unit 316. The signal transmitted from the loads estimation unit 306 may include data indicative of the estimated load determined by the loads estimation unit 306. The signal transmitted from the driver model unit 308 may include data indicative of an estimated path of the vehicle determined by the driver model unit 308. The signal transmitted from the vehicle model unit 310 may include data indicative of a predicted movement of one or more components of the vehicle determined by the vehicle model unit 310.

The control model unit 316 may determine an attribute parameter in dependence on the signals received from one or more of the loads estimation unit 306, the driver model 308 and the vehicle model unit 310. The control model unit 316 may output one or more signals in dependence on the one or more determined attribute parameters to one or more actuators 318a, 318b . . . 318z. The one or more actuators 318a, 318b, . . . , 318z may be controlled in dependence on the one or more signals received from the control model unit 316.

The control model unit 316 may further output a signal to the vehicle input fusion unit 304. The outputted signal may be in dependence on the one or more determined attribute parameters. This outputted signal may be the same as, or different to, the signal transmitted to the one or more actuators 318a, 318b, . . . 318z. The vehicle input fusion unit 304 may update data stored in a storage module of the input fusion unit 304 in response to the received signal from the control model unit 316. The input fusion unit 304 may process data stored within the input fusion unit 304 and/or received by the sensor unit 302 in dependence on the received signal from the control model unit 316. The vehicle input unit 304 may transmit a signal to one or more of the loads estimation unit 306, the driver model unit 308 and the vehicle model unit 310 in dependence on the received signal from the control model unit 316.

Each of the one or more actuators 318a, 318b, . . . 318z may transmit a signal to one or more actuator sensor data units 320. The signal transmitted by an actuator may be in dependence on one or more control settings of the actuator.

The actuator sensor data unit 320 may transmit a signal to the vehicle input fusion unit 304 in dependence on a signal received from the one or more actuators. The signal transmitted from the actuator sensor data unit 320 to the vehicle input fusion unit 304 may provide data relating to actuator states such as temperature or logical operational states of an actuator. The signal transmitted from the actuator sensor data unit 320 to the vehicle input fusion unit 304 may provide data relating to actuator internal specific measured quantities such as a voltage, current, torque, force, motor speed, pump flow or pressure acting on an actuator. The vehicle input fusion unit 304 may update data stored in a storage module of the input fusion unit 304 in response to the received signal from the actuator sensor data module 320. The input fusion unit 304 may process data stored within the input fusion unit 304 and/or received by the sensor unit 302 in dependence on the received signal from the actuator sensor data module 320. The vehicle input unit 304 may transmit a signal to one or more of the loads estimation unit 306, the driver model unit 308 and the vehicle model unit 310 in dependence on the received signal from the actuator sensor data module 320.

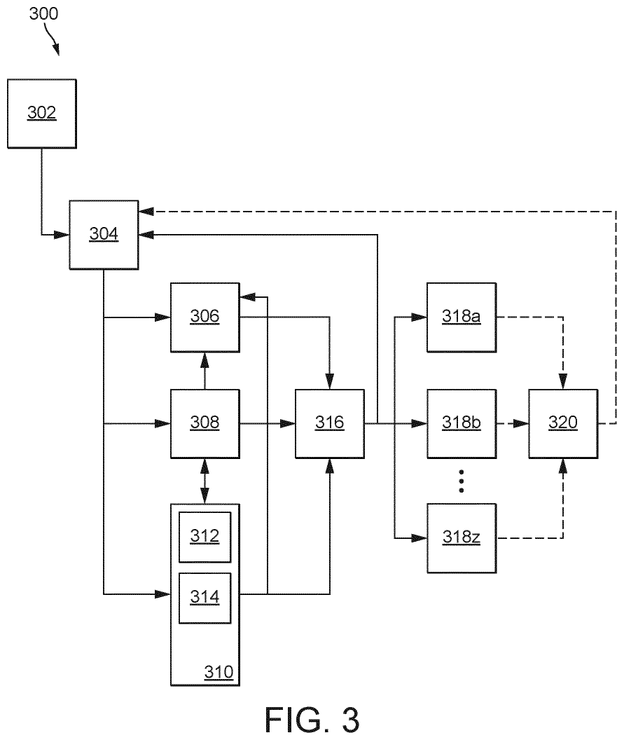

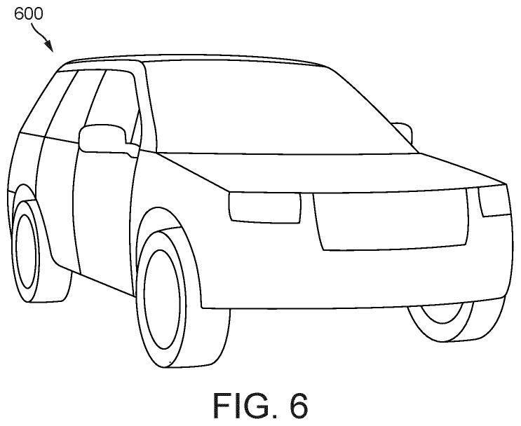

FIG. 4 illustrates an example method 400 of operating a control system of a vehicle 600, such as the vehicle 600 illustrated in FIG. 6. In particular, the method 400 is a method of pre-emptively controlling the actuators of a suspension system of a vehicle to reduce a load experienced by the vehicle in response to a condition of a driving surface. The method 400 may be performed by the system 100 illustrated in FIG. 1. In particular, the memory 130 may comprise computer-readable instructions which, when executed by the processor 120, perform a method 400 as disclosed herein.

The method comprises receiving a driving surface signal 402. Receiving a driving surface signal 402 means receiving a signal indicative of a property of a driving surface ahead of the vehicle. The driving surface signal may be received by one or more sensors of the vehicle or one or more external data sources.

The method further comprises determining one or more attribute parameters 404 of the actuator sets within the suspension system. The attribute parameter is determined in dependence on the received driving surface signal and on a current operational state of the vehicle. The attribute parameter is determined to keep a suspension force acting on a suspension system of the vehicle below a predetermined suspension force value.

The method further comprises outputting one or more actuator control signals 406. The actuator control signal is output to an actuator of the suspension system in dependence on the determined attribute parameter. The actuator control signal may comprise information relating to the determined one or more attribute parameters. The actuator control signal acts to control the actuator to cause the actuator to control a suspension force acting on the suspension system due to the movement of the vehicle along the driving surface.

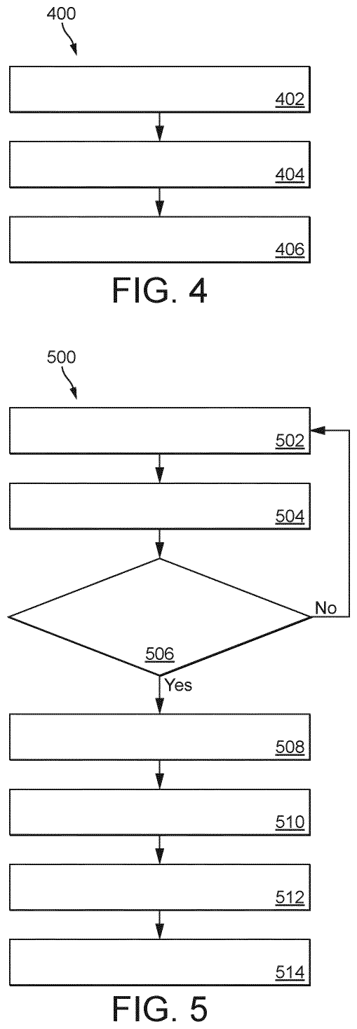

FIG. 5 illustrates an example method 500 of operating a control system of a vehicle 500, such as the vehicle 600 illustrated in FIG. 6. In particular, the method 500 is a method of pre-emptively controlling the actuators of a suspension system of a vehicle to reduce a load experienced by the vehicle in response to a condition of a driving surface. The method 500 may be performed by the system 100 illustrated in FIG. 1. In particular, the memory 130 may comprise computer-readable instructions which, when executed by the processor 120, perform the method 500 as disclosed herein.

The method 500 comprises receiving a driving surface signal 502. This step is the same as the corresponding step 402 described above in relation to FIG. 4. The method 500 further comprises determining a predicted suspension force 504. The predicted suspension force is the force expected to act on a suspension system of the vehicle as a result of the movement of the vehicle along the driving surface. The predicted suspension force is determined in dependence on the received driving surface signal indicating one or more properties of a driving surface ahead of the vehicle. The predicted suspension force is also determined in dependence on the current vehicle operational state of the vehicle.

The predicted suspension force may be determined using a vehicle model to predict loads as the vehicle passes over features of the driving surface. The vehicle model may predict a motion of the vehicle over the driving surface ahead of the vehicle, and predict a force that will arise from the predicted motion of the vehicle. The determined force arising from the predicted motion of the vehicle may be the predicted suspension force, or may be a different force that can itself be used to determine the predicted suspension force.

The method further comprises determining whether the predicted suspension force is greater than a threshold suspension force 506. The threshold suspension force may be referred to as a predetermined suspension force value.

In some examples, if the predicted suspension force is less than a threshold suspension force, an attribute parameter may not be calculated. The method 500 may then start again at receiving a driving surface signal 502. In some examples, if the predicted force is less than a threshold suspension force, the attribute parameter may still be calculated, but an actuator control signal providing information relating to the calculated attribute parameter may not necessarily be transmitted to an actuator.

If the predicted suspension force is greater than a threshold suspension force, then the attribute parameter may be determined 508. Determining the attribute parameter 508 may comprise the same features as explained above in relation to the corresponding step 404 of FIG. 4.

The attribute parameter may be determined 508 in dependence on the current vehicle operational state and a driver model to determine a predicted path of the vehicle. The driver model may represent a predicted vehicle operation by a driver of the vehicle. The attribute parameter may be determined 508 in dependence on at least one of the property of the driving surface and a route history pattern of the vehicle.

The current vehicle operational state may comprise one or more of a current speed, a current acceleration; a vehicle body motion, a wheel vertical displacement value, a wheel vertical speed, a wheel vertical acceleration, and a current suspension control state of the vehicle. The current speed may comprise a vehicle longitudinal and/or lateral speed. The current acceleration may comprise a vehicle longitudinal and/or lateral acceleration. The vehicle body motion may comprise one or more of a body roll, a pitch, and a yaw, and one or more of their corresponding time derivatives. The current vehicle operational state may further comprise any other settings or characteristics which may affect the operation of the vehicle, such as a mass of the vehicle, a mass distribution of the vehicle, or a current operational state of any other component or system of the vehicle.

The driver model to determine a predicted path of the vehicle may also be used to determine the predicted suspension force in step 504 of the method. This may provide a more accurate determination of the predicted suspension force.

The method 500 further comprises coordinating in time 510 the output of an actuator control signal to one or more actuators of the suspension system. The coordination may be determined using data relating to a current speed of a vehicle, an acceleration or deceleration of the vehicle, and a distance between the vehicle and a feature or area of the driving surface ahead of the vehicle.

The coordination of the actuator control signals may be implemented such that one or more actuators of the suspension system of the vehicle is in a desired state as the vehicle reaches the particular feature or area of the driving surface ahead of the vehicle.

The method 500 may further comprise outputting an actuator control signal 512 to an actuator of the vehicle. This step is the same as the corresponding step 406 described above in relation to FIG. 4.

The method 500 may further comprise reverting the controller operational state (and therefore the actuator functional behaviour) to its original state 514. That is, the actuator may be controlled to reverse any changes made to the operational settings or configuration of the actuator in response to receiving the actuator control signal. The controller operational state may revert to its original state after passing over the portion of the driving surface at which the actuator needed to be adjusted to keep the suspension force below a predetermined suspension force value. This reduces the amount of time that the actuator spends in the adjusted state, and therefore reduces the amount of time that the vehicle spends in a potentially more restrictive attribute compromise state.

FIG. 6 shows a vehicle 600 comprising a control system 100 as described above, or a system 100 as described above. The vehicle 600 in the present embodiment is an automobile, such as a wheeled vehicle, but it will be understood that the control system and active suspension system may be used in other types of vehicle.

As used here, ‘connected’ means either ‘mechanically connected’ or ‘electrically connected’ either directly or indirectly. Connection does not have to be galvanic. Where the control system is concerned, connected means operably coupled to the extent that messages are transmitted and received via the appropriate communication means.

It will be appreciated that various changes and modifications can be made to the present disclosed examples without departing from the scope of the present application as defined by the appended claims. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1-15. (canceled)

16. A control system for a suspension system of a vehicle, the control system comprising one or more controllers, the control system configured to:
receive a driving surface signal indicative of a property of a driving surface ahead of the vehicle;
determine, in dependence on the received driving surface signal and on a current vehicle operational state, an attribute parameter, wherein the attribute parameter, when provided to an actuator of the suspension system, causes the actuator to act to control a suspension force acting on the suspension system due to a movement of the vehicle along the driving surface to be below a predetermined suspension force value; and
output an actuator control signal to the actuator of the suspension system to control the actuator in dependence on the determined attribute parameter.

17. The control system of claim 16, configured to determine the attribute parameter in dependence on a vehicle model, and on the current vehicle operational state, to determine a predicted suspension force expected to arise as the vehicle travels over the driving surface ahead of the vehicle.

18. The control system of claim 17, wherein the predicted suspension force is determined using the vehicle model by:
predicting a motion of the vehicle over the driving surface ahead of the vehicle, and
predicting a force that will arise from the predicted motion of the vehicle.

19. The control system of claim 18, wherein:
if the predicted suspension force is greater than the predetermined suspension force value, the attribute parameter is determined; and
if the predicted suspension force is less than the predetermined suspension force value, the attribute parameter is not determined.

20. The control system of claim 16, configured to determine the attribute parameter in dependence on one or more of a driver model, a loads estimation model, and the current vehicle operational state, to determine a predicted path of the vehicle.

21. The control system of claim 20, wherein the driver model represents a predicted vehicle operation by a user of the vehicle, the predicted vehicle operation determined in dependence on at least one of the property of the driving surface and a route history pattern of the vehicle.

22. The control system of claim 16, wherein the current vehicle operational state comprises one or more of: a current speed, a current acceleration; a vehicle body motion, a wheel vertical displacement value, a wheel vertical speed, a wheel vertical acceleration, and a current suspension control state of the vehicle.

23. The control system of claim 22, wherein the current vehicle operational state comprises the current speed of the vehicle, and the control system is configured to coordinate in time the output of the actuator control signal to the actuator to control the actuator to be in a desired state when the vehicle reaches a portion of the driving surface whereby the suspension force is to be controlled to be below the predetermined threshold suspension force.

24. The control system of claim 16, wherein the control system is further configured to control the actuator to revert to a state that the actuator was in prior to receiving the actuator control signal, once the vehicle has passed a portion of the driving surface whereby the suspension force is to be controlled to be below the predetermined threshold suspension force.

25. The control system of claim 16, further comprising one or more sensors configured to obtain driving surface data relating to one or more properties of the driving surface ahead of the vehicle.

26. The control system of claim 16, wherein the suspension system comprises one or more of an active roll control system, an active damping system, an active spring system, an active steering system, and an active suspension system.

27. A system comprising a suspension system and the control system according to claim 16.

28. A vehicle comprising a control system according to claim 16.

29. A method of operating a control system for a suspension system of a vehicle, the method comprising:
receiving a driving surface signal indicative of a property of a driving surface in ahead of the vehicle;
determining, in dependence on the received driving surface signal and on a current vehicle operational state, an attribute parameter, wherein the attribute parameter, when provided to an actuator of the suspension system, causes the actuator to act to control a suspension force acting on the suspension system due to a movement of the vehicle along the driving surface, to be below a predetermined suspension force value; and
outputting an actuator control signal to the actuator of the suspension system to control the actuator in dependence on the determined attribute parameter.

30. A non-transitory computer readable medium comprising computer readable instructions that, when executed by a processor, cause performance of the method of claim 29.
